(19) United States
(12) Patent Application Publication
(10) Pub. No.: US 2025/0042539 A1
(43) Pub. Date: Feb. 6, 2025

(54) ROTARY ACTUATOR WITH REDUNDANT LOAD PATHS

(71) Applicant: Woodward, Inc., Fort Collins, CO (US)

(72) Inventors: Craig D. Mawle, Fort Collins, CO (US); Pawel A. Sobolewski, Rolling Meadows, IL (US)

(21) Appl. No.: 18/792,264

(22) Filed: Aug. 1, 2024

Related U.S. Application Data
(60) Provisional application No. 63/530,402, filed on Aug. 2, 2023.

(51) Int. Cl. B64C 13/36; B64C 9/02; F15B 15/08

(52) U.S. Cl. CPC B64C 13/36; B64C 9/02; F15B 15/08

(57) ABSTRACT

The subject matter of this specification can be embodied in, among other things, a rotary actuator having a housing with a first mounting assembly, a first mounting bracket adapted for attachment to the first mounting assembly and attachment to a first external mounting connector of a first mounting surface, a second mounting bracket adapted for attachment to the first mounting assembly and attachment to the first external mounting connector, a rotor assembly rotatably journaled in said housing and having a rotary output shaft having a second mounting assembly, a third mounting bracket adapted for attachment to the rotary output shaft and adapted for attachment to a second external mounting connector of a second mounting surface, and a fourth mounting bracket adapted for attachment to the rotary output shaft and adapted for attachment to the second external mounting connector.

### CROSS-REFERENCE TO RELATED PATENT APPLICATIONS

This application claims the benefit of priority to U.S. Provisional Patent Application No. 63/530,402, filed Aug. 2, 2023, the contents of which are incorporated by reference herein.

### TECHNICAL FIELD

This instant specification relates to rotary hydraulic actuators with redundant load paths.

### BACKGROUND

Rotary hydraulic actuators of various forms are currently used in industrial mechanical power conversion applications. This industrial usage is commonly for applications where continuous inertial loading is desired without the need for load holding for long durations, e.g., hours, without the use of an external fluid power supply. One such application is in aircraft flight control. Aircraft flight control applications generally implement loaded positional holding, for example, in a failure mitigation mode, using substantially only the blocked fluid column to hold position.

In certain applications utilizing rotary hydraulic actuator, such as primary flight controls used for aircraft operation, a high level of reliability is critical. For example, a mechanical failure (e.g., a stress fracture) between the flight control and airframe can lead to an uncontrolled and potentially dangerous movement of the flight control surface, also known as “flutter”, which is a form of self-excited oscillation and/or vibration caused by interactions between aerodynamic and inertial forces that can cause mechanical damage to the aircraft, buffeting of the aircraft, and potential loss of aircraft control.

Previous surface actuators have typically been mounted between wing ribs, which can cause torque moments between the actuator and the ribs when such actuators are loaded. Such previous arrangements have typically required additional material to stiffen the rib. This creates a bending moment in the supporting spar and a complex load reaction path that can cause mechanical distortions (e.g., bending of a portion of the airframe), malfunctions (e.g., binding within the actuator), and/or damage (e.g., stress fractures, metal fatigue), any of which could have negative effects on aircraft operation and readiness.

### SUMMARY

In general, this document describes rotary hydraulic actuators with redundant load paths.

In a general example, a rotary actuator includes a housing with a first mounting assembly, a first mounting bracket adapted for attachment to the first mounting assembly at a first proximal end, and adapted at a first distal end for attachment to a first external mounting connector of a first mounting surface, a second mounting bracket adapted for attachment to the first mounting assembly at a second proximal end, and adapted at a second distal end for attachment to the first external mounting connector, a rotor assembly rotatably journaled in said housing and having a rotary output shaft having a second mounting assembly, a third mounting bracket adapted for attachment to the rotary output shaft at a third proximal end, and adapted at a third distal end for attachment to a second external mounting connector of a second mounting surface, and a fourth mounting bracket adapted for attachment to the rotary output shaft at a fourth proximal end, and adapted at a fourth distal end for attachment to the second external mounting connector.

Various examples can include some, all, or none of the following features. The first mounting bracket and the second mounting bracket can be formed as separate bodies, or the third mounting bracket and the fourth mounting bracket can be formed as separate bodies or both. A first major face of the first mounting bracket can abut a second major face of the second mounting bracket, or a third major face of the third mounting bracket can abut a fourth major face of the fourth mounting, or both. The first mounting surface can include an aircraft airframe structural member, and the first external mounting connector can be proximal a structural rib of the aircraft airframe structural member. The second mounting surface can include a mounting feature of an aircraft assembly to be actuated, and the second external mounting connector can be proximal a structural rib of the aircraft assembly. The rotary output shaft can include a first shaft assembly having the second mounting assembly and a second shaft assembly having a third mounting assembly. The rotary actuator can include a fifth mounting bracket adapted for attachment to the second mounting assembly at a fifth proximal end, and adapted at a fifth distal end for attachment to a third external mounting connector of the second mounting assembly, and a sixth mounting bracket adapted for attachment to the third mounting assembly at a sixth proximal end, and adapted at a sixth distal end for attachment to the third external mounting connector.

In another general example, an aircraft assembly includes an airframe having a first mounting surface having a first external mounting connector, an aircraft member configured to be moved relative to the airframe and having a second mounting surface having a second external mounting connector, and a rotary actuator having a housing having a first mounting assembly, a first mounting bracket adapted for attachment to the first mounting assembly at a first proximal end, and adapted at a first distal end for attachment to a first external mounting connector of a first mounting surface, a second mounting bracket adapted for attachment to the first mounting assembly at a second proximal end, and adapted at a second distal end for attachment to the first external mounting connector, a rotor assembly rotatably journaled in said housing and having a rotary output shaft and having a second mounting assembly, a third mounting bracket adapted for attachment to the rotary output shaft at a third proximal end, and adapted at a third distal end for attachment to a second external mounting connector of a second mounting surface, and a fourth mounting bracket adapted for attachment to the rotary output shaft at a fourth proximal end, and adapted at a fourth distal end for attachment to the second external mounting connector.

Various examples can include some, all, or none of the following features. The first mounting bracket and the second mounting bracket can be formed as separate bodies, or the third mounting bracket and the fourth mounting bracket can be formed as separate bodies, or both. A first major face of the first mounting bracket can abut a second major face of the second mounting bracket, or a third major face of the third mounting bracket can abut a fourth major face of the fourth mounting bracket, or both. The first mounting surface can include an aircraft airframe structural member, and the first external mounting connector can be proximal a structural rib of the aircraft airframe structural member. The second mounting surface can include a mounting feature of an aircraft assembly to be actuated, and the second external mounting connector can be proximal a structural rib of the aircraft assembly. The rotary output shaft can include a first shaft assembly having the second mounting assembly and a second shaft assembly having a third mounting assembly. The aircraft assembly can include a fifth mounting bracket adapted for attachment to the second mounting assembly at a fifth proximal end, and adapted at a fifth distal end for attachment to a third external mounting connector of the second mounting surface, and a sixth mounting bracket adapted for attachment to the third mounting assembly at a sixth proximal end, and adapted at a sixth distal end for attachment to the third external mounting connector.

In another general example, a method of rotary actuation includes providing a rotary actuator that includes a housing having a first mounting assembly, a first mounting bracket adapted for attachment to the first mounting assembly at a first proximal end, and adapted at a first distal end for attachment to a first external mounting connector of a first mounting surface, a second mounting bracket adapted for attachment to the first mounting assembly at a second proximal end, and adapted at a second distal end for attachment to the first external mounting connector, a rotor assembly rotatably journaled in said housing and having a rotary output shaft and having a second mounting assembly, a third mounting bracket adapted for attachment to the rotary output shaft at a third proximal end, and adapted at a third distal end for attachment to a second external mounting connector of a second mounting surface, and a fourth mounting bracket adapted for attachment to the rotary output shaft at a fourth proximal end, and adapted at a fourth distal end for attachment to the second external mounting connector, energizing the rotor assembly, urging rotation of the rotary output shaft, urging, by the rotary output shaft, rotation of the third mounting bracket, urging, by the rotary output shaft, rotation of the fourth mounting bracket, and urging, by the third mounting bracket and the fourth mounting bracket, motion of the second external mounting connector.

Various examples can include some, all, or none of the following features. The first mounting bracket and the second mounting bracket can be formed as separate bodies, or the third mounting bracket and the fourth mounting bracket can be formed as separate bodies, or both. A first major face of the first mounting bracket can abut a second major face of the second mounting bracket, or a third major face of the third mounting bracket can abut a fourth major face of the fourth mounting bracket, or both. The second mounting surface can include a mounting feature of an aircraft assembly to be actuated, and the second external mounting connector can be proximal a structural rib of the aircraft assembly. The rotary output shaft can include a first shaft assembly having the second mounting assembly and a second shaft assembly having a third mounting assembly. The method can include a fifth mounting bracket adapted for attachment to the second mounting assembly at a fifth proximal end, and adapted at a fifth distal end for attachment to a third external mounting connector of the second mounting surface, and a sixth mounting bracket adapted for attachment to the third mounting assembly at a sixth proximal end, and adapted at a sixth distal end for attachment to the third external mounting connector.

The systems and techniques described here may provide one or more of the following advantages. First, a system can reduce overall system weight. Second, the system can improve the load path of a rotary actuator attached to a surface. Third, the system can improve surface attachment redundancy. Fourth, the system can reduce component weight and cost by integrating such redundancy into a rotary actuator.

The details of one or more implementations are set forth in the accompanying drawings and the description below. Other features and advantages will be apparent from the description and drawings, and from the claims.

### DESCRIPTION OF DRAWINGS

FIG. 1 is a perspective view of an example rotary hydraulic actuator with redundant load paths.

FIG. 2 is a block diagram of an example rotary hydraulic actuator with redundant load paths.

FIG. 3 is another perspective view of the example rotary hydraulic actuator of FIG. 1.

FIG. 4 is an exploded perspective view of the example rotary hydraulic actuator of FIGS. 1 and 3.

FIG. 5 is a top view of the example rotary hydraulic actuator of FIGS. 1, 3 and 4.

FIG. 6 is an exploded top view of the example rotary hydraulic actuator of FIGS. 1 and 3-5.

FIG. 7 is a front view of the example rotary hydraulic actuator of FIGS. 1 and 3-6.

FIG. 8 is a sectional top view of the example rotary hydraulic actuator of FIGS. 1 and 3-7.

FIG. 9 is a flow chart that shows an example of a process for using a rotary hydraulic actuator.

FIG. 10 shows a schematic diagram of another example rotary hydraulic actuator.

### DETAILED DESCRIPTION

This document describes rotary hydraulic actuators with redundant load paths. In general, rotary hydraulic actuators are configured to actuate a load (e.g., an aircraft control surface) relative to a connected surface or object (e.g., an airframe). In the designs of conventional actuators, most or all of the forces carried by the actuator are channeled through potential single (e.g., non-redundant) points of failure as the forces are transferred between the actuator load and the airframe. A malfunction (e.g., fracture) of one of these single points of failure could lead to a loss of actuator control, a loss of control surface control, and potentially a loss of aircraft control. Thus, there is a need for actuators that do not present single points of failure and can remain operational in the event of a failure along an internal load-bearing path.

To satisfy this need, the rotary hydraulic actuators described below are configured with multiple redundant, substantially parallel mechanical connections between the load and the connected object. The actuators described below implement designs in which the redundancies are integrated into the core design, thus reducing overall weight and cost while improving the reliability of the load path between the load and the structure to which the actuator is attached and improving surface attachment redundancy. In the event of a failure of one of the redundant connections, another of the redundant connections can continue to carry the load. This eliminates any single failure path that could lead to a dangerous and/or destructive flutter condition in an aircraft control implementation.

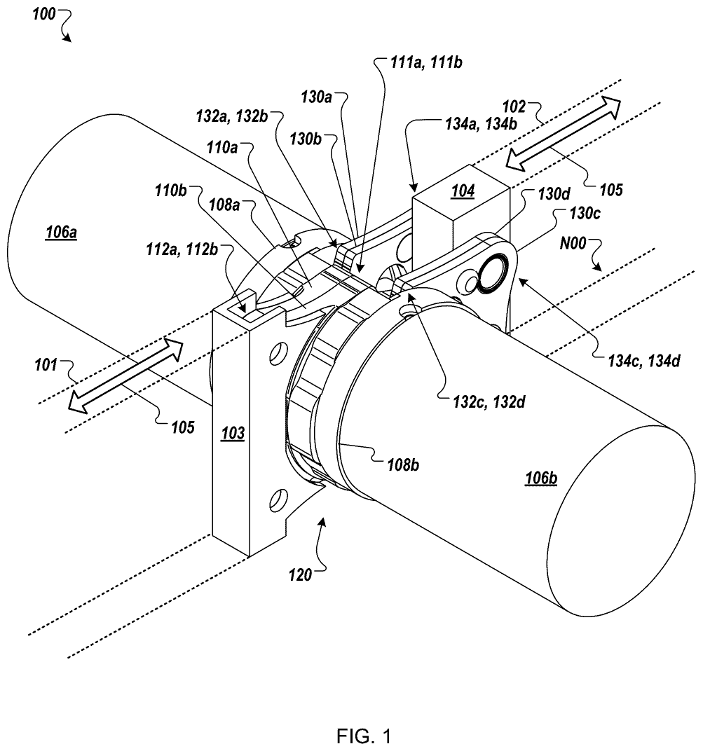

FIG. 1 is a perspective view of an example rotary hydraulic actuator 100 with redundant load paths that will be described in more detail below. The actuator 100 is configured as a powered hinge between a mounting surface 101 (e.g., rib) of an aircraft airframe structure and a control surface 102 or other moveable aircraft member.

The actuator 100 includes a housing 106a having a mounting assembly 108a. The actuator 100 includes a mounting bracket 110a adapted for attachment to a mounting assembly 108a at a proximal end 111a, and adapted at a distal end 112a for attachment to an external mounting connector 103 of a mounting surface. In some implementations, the mounting surface 101 can be an aircraft airframe structural member. In some implementations, the mounting surface 101 can be a structural rib of an airframe. For example, structural ribs can be among the structurally strongest points on an aircraft or other structure, and the actuator 100 can be configured to have the mounting bracket 110a aligned with a structural rib. In such configurations, actuation of the actuator 100 can be in-line with the structural rib and reduce or substantially eliminate twisting moments between an actuator mounting point and the rib.

The actuator 100 includes a housing 106b having a mounting assembly 108b. The actuator 100 includes a mounting bracket 110b adapted for attachment to the mounting assembly 108b at a proximal end 111b, and adapted at a distal end 112b for attachment to an external mounting connector 103 of a mounting surface 101. In some implementations, the mounting surface 101 can be an airframe of an aircraft. In some implementations, the mounting surface 101 can be proximal to a structural rib of an airframe. For example, structural ribs can be among the structurally strongest points on an aircraft or other structure, and the actuator 100 can be configured to have the mounting bracket 110b aligned with a structural rib. In such configurations, actuation of the actuator 100 can be in-line with the structural rib and reduce or substantially eliminate twisting moments between an actuator mounting point and the rib. In previous designs in which actuators are affixed to structural members (e.g., spars) that run substantially parallel to the ribs, rotary/hinged actuation loads can twist the spars, leading to distortion of the airframe and/or cause stress points at the junctions between the spar and surrounding ribs, either of which can cause fatigue and/or failure of the affected components. By aligning the actuator with the rib, the twisting moments are transmitted more directly to the rib, which is structurally more well-suited to handle such stresses safely.

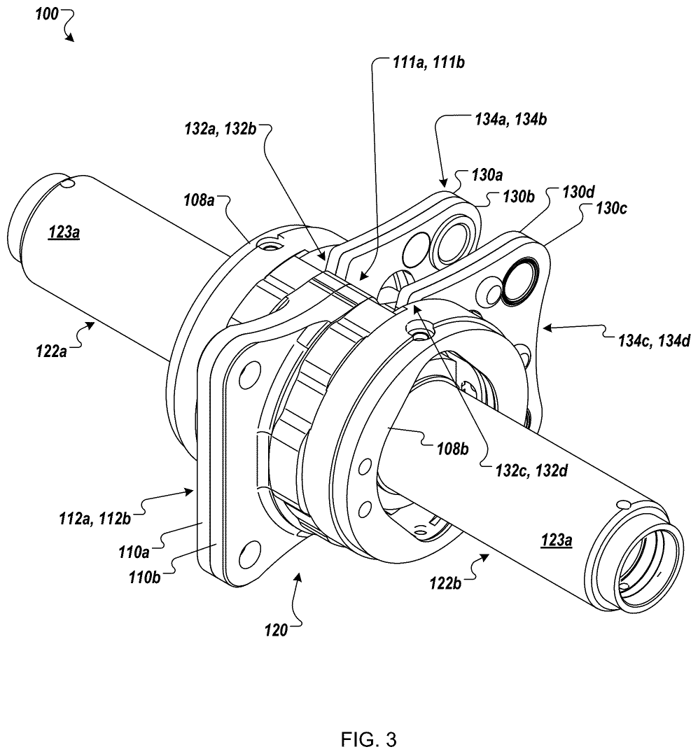

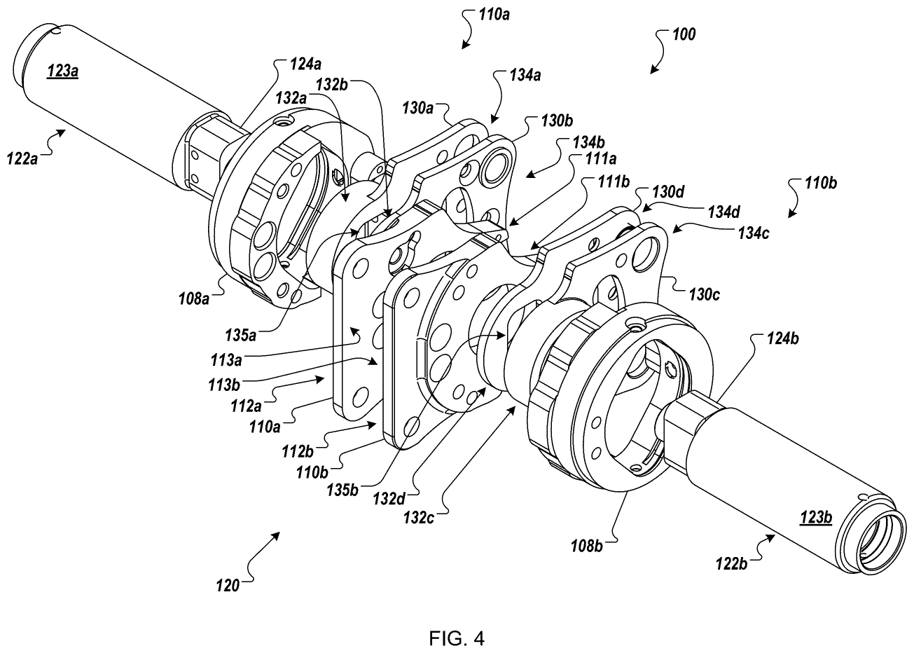

The actuator 100 includes a rotor assembly 120, visible in FIGS. 3-8. The rotor assembly 120 is rotatably journaled in the housings 106a-106b, and includes a rotary output shaft 122a and a rotary output shaft 122b. As best seen in FIGS. 4, 6, and 8, the rotary output shaft 122a has a shaft assembly 123a and a mounting assembly 124a, and the rotary output shaft 122b has a shaft assembly 123b and a mounting assembly 124b.

Referring again to FIGS. 1 and 3-8, the actuator 100 includes a mounting bracket 130a adapted for attachment to the rotary output shaft 122a at a proximal end 132a, and adapted at a distal end 134a for attachment to the mounting connector 104 of the control surface 102 (e.g., a mounting feature of an aircraft assembly to be actuated). In some implementations, the control surface 102 can be a control surface of an aircraft (e.g., aileron, flap, rudder). The actuator 100 includes a mounting bracket 130b adapted for attachment to the rotary output shaft 122a at a proximal end 132b, and adapted at a distal end 134b for attachment to the external mounting connector 104.

The actuator 100 includes a mounting bracket 130c adapted for attachment to the rotary output shaft 122b at a proximal end 132c, and adapted at a distal end 134c for attachment to the mounting connector 104 of the control surface 102. The actuator 100 includes a mounting bracket 130d adapted for attachment to the rotary output shaft 122b at a proximal end 132d, and adapted at a distal end 134d for attachment to the external mounting connector 104.

Previous surface actuators have typically been mounted between wing ribs, which can cause torque moments between the actuator and the ribs when such actuators are loaded. Such previous arrangements have typically required additional material to stiffen the rib. This creates a bending moment in the supporting spar and a complex load reaction path. Placing a rotary actuator at the same location as the typical linear actuator requires similar spar stiffening and weight as well. Twisting of a spar can cause unwanted distortion of the airframe, and repeated twisting can lead to mechanical fatigue and/or failure. Such spars can be stiffened through the addition of reinforcing materials, but such additional material also inherently adds weight and cost to an aircraft, thus increasing the cost of production of the aircraft while simultaneously reducing the operational capabilities of the aircraft.

In some embodiments, spars and ribs within an airframe can be some of the structurally strongest components in an airframe. In the illustrated example, the actuator 100 mounted in alignment with the mounting surface 101 (e.g., a rib). By affixing the actuator 100 in line with the mounting surface 101, forces and loads experienced by the actuator 100 (as represented by arrows 105) can be transferred to the mounting surface 101, substantially without creating complex load reaction paths that can twist under load and substantially without requiring the weight of the additional stiffening that is typically required by previous arrangements.

The actuator 100 will be discussed in further detail in the descriptions of FIGS. 3-8.

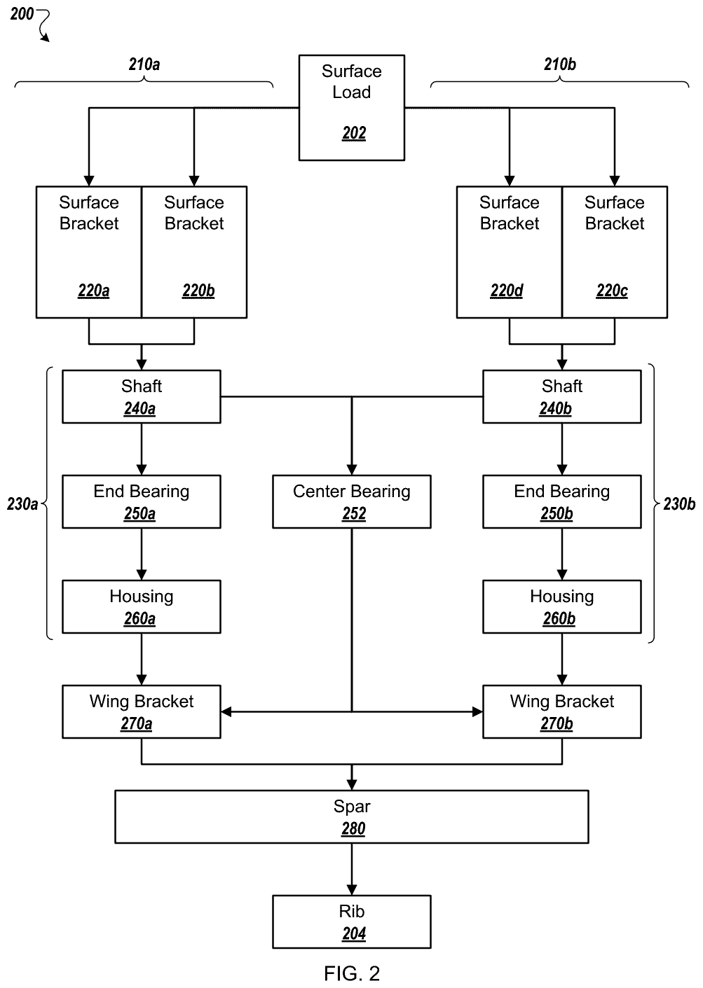

FIG. 2 is a block diagram of an example rotary hydraulic actuator 200 with redundant load paths. In some embodiments, the actuator 200 can be a representation of the example actuator 100 of FIG. 1. In general, the actuator 200 is configured to carry a load between a surface load 202 and a structural rib 204 through a load path 210a and a load path 210b. The load paths 210a-210b are each configured to be independently capable of carrying the load between the surface load 202 and the structural rib 204, and are redundant to each other in the illustrated example.

The load path 210a carries some or all of the load (e.g., about 50% of the total load under normal conditions) through a surface bracket 220a and a surface bracket 220b. The surface bracket 220a is configured to transmit torque between the surface load 202 and the structural rib 204, while the surface bracket 220b is configured to carry only the load between the surface load 202 and the structural rib 204. Under nominal operational conditions, the surface brackets 220a and 220b cooperatively carry half the load applied to the actuator 200 (e.g., each of the surface brackets 220a-220b carry about 25% of the total load under normal conditions). The surface brackets 220a-220b are redundant to allow for full operation with no degradation with a single failure. For example, if the surface bracket 220a fails, then the surface bracket 220b can carry 50% of the total load as opposed to the 25% it saw before.

The load and torque are then transmitted to a rotary actuator 230a. The rotary actuator 230a includes a rotor shaft 240a that is partly carried by an end bearing 250a and partly carried by a center bearing 252, and a housing 260a. The rotor shaft 240a and the housing 260a are configured to act as a rotor and stator, respectively, of a rotary actuator apparatus. For example, the rotor shaft 240a can be affixed to rotary pistons that are configured to actuate within pressure chambers affixed to or defined within the housing 260a. In some embodiments, the rotary actuator 230a can be a fluid actuator (e.g., a rotary piston actuator, a rotary vane actuator), an electrical actuator (e.g., electric motor), or any other appropriate type of rotary actuator.

The housing 260a is configured to transmit load and torque between the rotary actuator 230a and a wing bracket 270a affixed to the housing 260a. The wing bracket 270a is affixed to a spar 280 that extends span-wise at a generally right angle to an aircraft fuselage. In some implementations, the spar 280 can carry flight loads and the weight of the wings while on the ground. The spar 280 is affixed to the structural rib 204. In some implementations, the structural rib 204 can be affixed substantially perpendicular to the spar 280 and can form a portion of the skeletal shape for an aircraft wing. In some implementations, the structural rib 204 can at least partly incorporate an airfoil shape of the wing, and the skin of the wing can adopt this shape when extended over the ribs.

The load path 210b carries some or all of the load (e.g., about 50% of the total load under normal conditions) through a surface bracket 220c and a surface bracket 220d. The surface bracket 220d is configured to transmit torque between the surface load 202 and the structural rib 204, while the surface bracket 220c is configured to carry only the load between the surface load 202 and the structural rib 204. Under nominal operational conditions, the surface brackets 220c and 220d cooperatively carry half the load applied to the actuator 200 (e.g., each of the surface brackets 220c-220d carry about 25% of the total load under normal conditions). The surface brackets 220c-220d are redundant to allow for full operation with no degradation with a single failure. For example, if the surface bracket 220c fails, then the surface bracket 220d can carry 50% of the total load as opposed to the 25% it saw before.

The load and torque are then transmitted to a rotary actuator 230b. The rotary actuator 230b includes a rotor shaft 240b that is partly carried by an end bearing 250b and partly carried by a center bearing 252, and a housing 260b. The rotor shaft 240b and the housing 260b are configured to act as a rotor and stator, respectively, of a rotary actuator apparatus. For example, the rotor shaft 240b can be affixed to rotary pistons that are configured to actuate within pressure chambers affixed to or defined within the housing 260b. In some embodiments, the rotary actuator 230b can be a fluid actuator (e.g., a rotary piston actuator, a rotary vane actuator), an electrical actuator (e.g., electric motor), or any other appropriate type of rotary actuator.

The housing 260b is configured to transmit load and torque between the rotary actuator 230b and a wing bracket 270b affixed to the housing 260b. The wing bracket 270b is affixed to the spar 280.

The rotor shaft 240a and the rotor shaft 240b are rotationally coupled to each other. By coupling the rotor shafts 240a-240b together, some failure modes of the load paths 210a-210b can be mitigated. For example, in the event of a failure of the wing bracket 270a, power from the rotary actuator 230a can still be transferred through the rotor shaft 240a to the rotor shaft 240b, through the rotary actuator 230b to the spar 280 through the wing bracket 270b.

The wing bracket 270a and wing bracket 270b are coupled to each other as well as to the spar 280. By coupling the wing brackets 270a-270b together, some failure modes of the load paths 210a-210b can be mitigated. For example, the wing brackets 270a and 270b can carry approximately 50% of the load and/or torque each. In the event of a failure of the wing bracket 270a, loads and/or torques (e.g., 100% of the load and torque) from the surface load 202 can still be transferred along the load path 210a, through the wing bracket 270b to the spar 280 through the wing bracket 270b.

In some implementations, the wing brackets 270a and/or 270b can be affixed to the spar 280 at a location that is substantially aligned with the structural rib 204. For example, the structural rib 204 can provide one of the relatively strongest structural points on an aircraft wing. By affixing the wing brackets 270a and/or 270b in line with the structural rib 204, torques and loads of the surface load 202 can be transmitted to and/or carried by the structural rib 204 substantially without inducing twisting moments along the spar 280.

In the illustrated example, the rotary hydraulic actuator 200 has been described as connecting aircraft control surfaces (e.g., the surface load 202) to an airframe (e.g., the spar 280), but in some examples the rotary hydraulic actuator 200 can be used between any two appropriate structures that can be actuated relative to each other (e.g., as a joint in a machine or robotic arm, as a powered hinge).

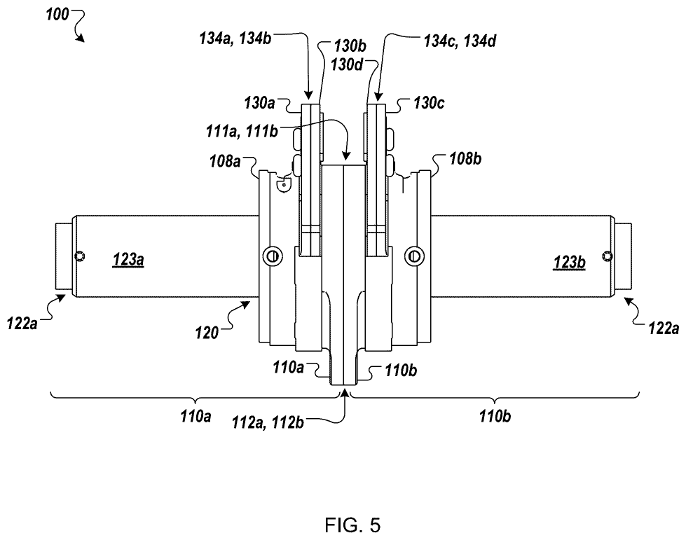

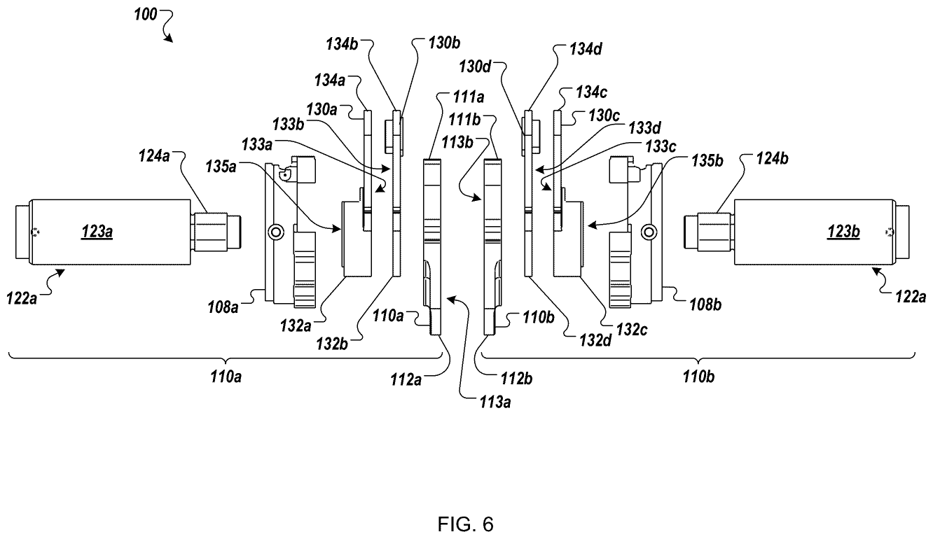

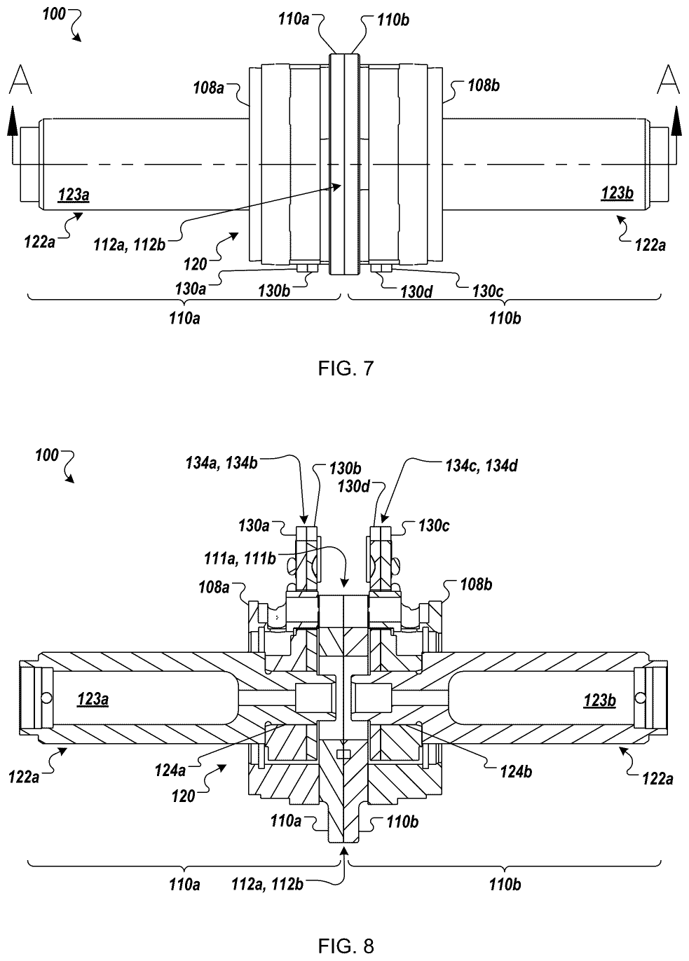

FIGS. 3-8 are various views of the example rotary hydraulic actuator 100 of FIG. 1, without showing the mounting surface 101, the control surface 102, the external mounting connectors 103 and 104, and the housings 106a and 106b to make other components more visible for the purpose of description. FIG. 3 is another perspective view of the rotary hydraulic actuator 100. FIG. 4 is an exploded perspective view of the example rotary hydraulic actuator 100. FIG. 5 is a top view of the example rotary hydraulic actuator 100. FIG. 6 is an exploded top view of the example rotary hydraulic actuator 100. FIG. 7 is a front view of the example rotary hydraulic actuator 100. FIG. 8 is a sectional top view of the example rotary hydraulic actuator 100 taken along section A-A of FIG. 7.

The rotary output shaft 122a and the mounting assembly 124a of the example rotary hydraulic actuator 100 are configured to rotate relative to the housing 106a. For example, the rotary output shaft 122a can be affixed to rotary pistons that are configured to fit within corresponding cavities defined in the housing 106a to define fluid chambers, and fluid pressure can be applied to such fluid chambers to urge movement of the rotary pistons, the rotary output shaft 122a, and the mounting assembly 124a relative to the housing 106a, the mounting bracket 110a, and the mounting bracket 110b. In another example, the rotary output shaft 122a can be affixed to one or more vanes that are configured to partly define one or more cavities defined in the housing 106a to define fluid chambers, and fluid pressure can be applied to such fluid chambers to urge movement of the rotary vanes, the rotary output shaft 122a, and the mounting assembly 124a relative to the housing 106a, the mounting bracket 110a, and the mounting bracket 110b. Similarly, the rotary output shaft 122b and the mounting assembly 124b are configured to rotate relative to the housing 106b.

The mounting assembly 124a of the example rotary hydraulic actuator 100 is defined with non-circular shape (e.g., as best seen in FIG. 4, a rounded rectangular shape). The mounting bracket 130a and the mounting bracket 130b each include a bore 135a having a shape that is configured to matingly engage the mounting assembly 124a such that rotation of the rotary output shaft 122a urges pivotal movement of the mounting bracket 130a and the mounting bracket 130b relative to the mounting brackets 110a-110b. The mounting bracket 130c and the mounting bracket 130d are similarly configured with a bore 135b that rotationally engage the mounting assembly 124b such that rotation of the rotary output shaft 122a urges pivotal movement of the mounting bracket 130c and the mounting bracket 130d relative to the mounting brackets 110a-110b.

The mounting brackets 110a, 110b, and 130a-130d are each formed as separate bodies. The mounting brackets 110a and 110b are each configured as generally flat, plate-like assemblies. The mounting bracket 110a defines a major face 113a and the mounting bracket 110b defines a major face 113b. The mounting brackets 110a and 110b are arranged in parallel, such that the major face 113a abuts the major face 113b. In the illustrated example, the mounting brackets 110a and 110b are in direct mechanical contact with each other at the major faces 113a-113b. In some implementations, the mounting brackets 110a and 110b can be in indirect mechanical contact, with an intermediary layer arranged between the major faces 113a-113b.

In use, the mounting bracket 110a and the mounting bracket 110b are mechanically redundant to each other. The mounting bracket 110a and the mounting bracket 110b are each configured to carry a predetermined (e.g., rated) load and stress that can be transmitted between the actuator 100 and the external mounting connector 103. For example, if one of mounting bracket 110a or mounting bracket 110b were to fail (e.g., fracture, crack), then the remaining mounting bracket can continue to carry the load such that the actuator 100 can continue to operate safely.

The mounting brackets 130a and 130b of the example rotary hydraulic actuator 100 are each configured as generally flat, plate-like assemblies. The mounting bracket 130a defines a major face 133a and the mounting bracket 130b defines a major face 133b. The mounting brackets 130a and 130b are arranged in parallel, such that the major face 133a abuts the major face 133b. In the illustrated example, the mounting brackets 130a and 130b are in direct mechanical contact with each other at the major faces 133a-133b. In some implementations, the mounting brackets 130a and 130b can be in indirect mechanical contact, with an intermediary layer arranged between the major faces 133a-133b.

The mounting brackets 130c and 130d are each configured as generally flat, plate-like assemblies. The mounting bracket 130c defines a major face 133c and the mounting bracket 130d defines a major face 133d. The mounting brackets 130c and 130d are arranged in parallel, such that the major face 133c abuts the major face 133d. In the illustrated example, the mounting brackets 130c and 130d are in direct mechanical contact with each other at the major faces 133c-133d. In some implementations, the mounting brackets 130c and 130d can be in indirect mechanical contact, with an intermediary layer arranged between the major faces 133c-133d.

In use, the mounting bracket 130a and the mounting bracket 130b are mechanically redundant to each other, and the mounting bracket 130c and the mounting bracket 130d are mechanically redundant to each other. The mounting bracket 130a and the mounting bracket 130b are each configured to carry a predetermined (e.g., rated) load and stress that can be transmitted between the actuator 100 and the mounting connector 104. For example, if one of mounting bracket 130a or mounting bracket 130b were to fail (e.g., fracture, crack), then the remaining mounting bracket can continue to carry the load such that the actuator 100 can continue to operate safely. Similarly, the mounting bracket 130c and the mounting bracket 130d are each configured to carry a predetermined (e.g., rated) load and stress that can be transmitted between the actuator 100 and the mounting connector 104.

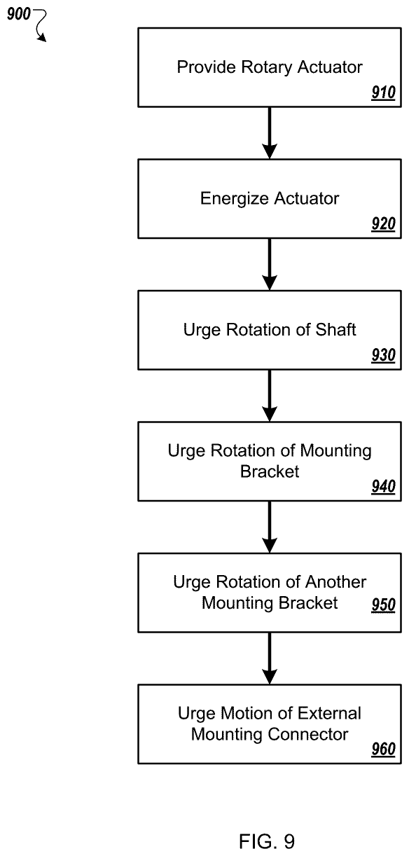

FIG. 9 is a flow chart that shows an example of a process 900 for using a rotary hydraulic actuator. In some implementations, the process 900 can be performed by all or part of the example actuator 100 or the example actuator 200 of FIGS. 1-8.

At 910, a rotary actuator is provided. The rotary actuator includes a housing having a first mounting assembly, a first mounting bracket adapted for attachment to the first mounting assembly at a first proximal end and adapted at a first distal end for attachment to a first external mounting connector of a first mounting surface, a second mounting bracket adapted for attachment to the first mounting assembly at a second proximal end and adapted at a second distal end for attachment to the first external mounting connector, a rotor assembly rotatably journaled in said housing and including a rotary output shaft and comprising a second mounting assembly, a third mounting bracket adapted for attachment to the rotary output shaft at a third proximal end and adapted at a third distal end for attachment to a second external mounting connector of a second mounting surface, and a fourth mounting bracket adapted for attachment to the rotary output shaft at a fourth proximal end and adapted at a fourth distal end for attachment to the second external mounting connector. For example, the example actuator 100 or the example actuator 200 can be provided.

At 920, the rotor assembly is energized. For example, fluid pressure can be applied to the actuator 100. In some implementations, the actuator 100 can be any appropriate type of rotary actuator, such as an electric actuator that can be energized.

At 930, rotation of the rotary output shaft is urged. For example, fluid pressure applied to the actuator 100 can urge rotation of the rotary output shaft 122a and/or the rotary output shaft 122b. In examples of electrical actuators, electric current can be applied to the electrical actuator to urge rotation of a rotor.

At 940, the rotary output shaft urges rotation of the third mounting bracket. For example, rotation of the rotary output shaft 122a can urge pivotal motion of the mounting bracket 130a relative to the housing 106a and the mounting brackets 110a-110b.

At 950, the rotary output shaft urges rotation of the fourth mounting bracket. For example, rotation of the rotary output shaft 122a can urge pivotal motion of the mounting bracket 130b relative to the housing 106a and the mounting brackets 110a-110b.

At 960, the third mounting bracket and the fourth mounting bracket urge motion of the second external mounting connector. For example, movement of the mounting bracket 103a and the mounting bracket 130b can urge movement of the mounting connector 104 to which they can be affixed.

In some implementations, the first mounting bracket and the second mounting bracket can be formed as separate bodies, or the third mounting bracket and the fourth mounting bracket can be formed as separate bodies, or both. For example, the mounting brackets 110a-110b can be configured as mechanically separate or separable subassemblies, and/or two or more of the mounting brackets 130a-130d can be configured as mechanically separate or separable subassemblies.

In some implementations, a first major face of the first mounting bracket can abut a second major face of the second mounting bracket, or a third major face of the third mounting bracket abuts a fourth major face of the fourth mounting bracket; or both. For example, the major face 113a can abut the major face 113b, the major face 133a can abut the major face 133b, and/or the major face 133c can abut the major face 133d.

In some implementations, the second mounting surface can include a mounting feature of an aircraft assembly to be actuated, and the second external mounting connector can be proximal a structural rib of the aircraft assembly. For example, the mounting surface 101 (e.g., a structural rib of an airframe) can include the external mounting connector 103, which can be arranged in alignment with or proximal to alignment with the mounting surface 101.

In some implementations, the rotary output shaft can include a first shaft assembly comprising the second mounting assembly and a second shaft assembly comprising a third mounting assembly. For example, the rotor assembly 120 can include the shaft assembly 123a and the mounting assembly 124a, can include and the shaft assembly 123a and the mounting assembly 124a.

In some implementations, a fifth mounting bracket can be adapted for attachment to the second mounting assembly at a fifth proximal end and adapted at a fifth distal end for attachment to a third external mounting connector of the second mounting surface, and a sixth mounting bracket can be adapted for attachment to the third mounting assembly at a sixth proximal end and adapted at a sixth distal end for attachment to the third external mounting connector. For example, the actuator 100 can include the mounting brackets 130c and 130d to connect the rotary output shaft 122b to the external mounting connector 104.

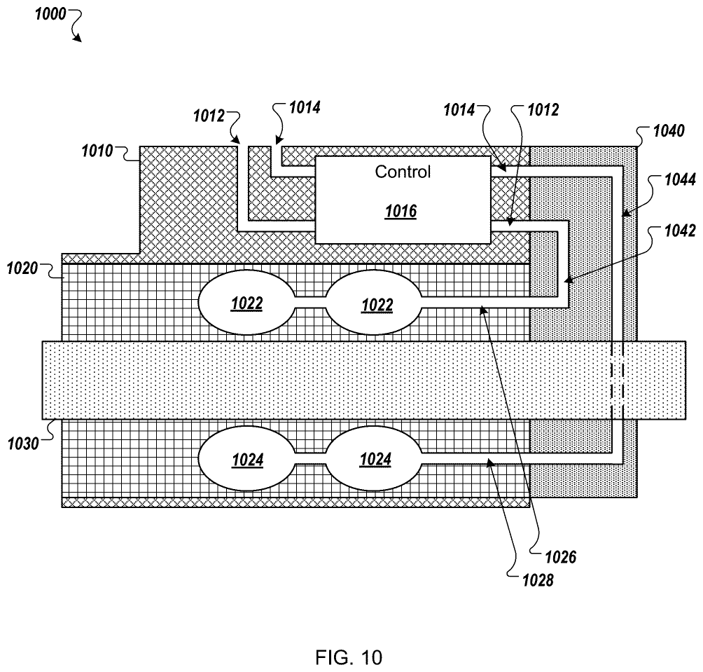

FIG. 10 shows a schematic diagram of another example rotary hydraulic actuator 1000. In some implementations, the example actuators 100 and 200 of FIGS. 1-8 can be modified to include some or all of the features of the example rotary hydraulic actuator 1000.

In general, the actuator 1000 includes fluid passages and fluid control features that are defined partly or entirely by a housing assembly of the actuator. By forming fluid conduits, manifolds, and/or control chambers as integral parts of the actuator 100, mechanical complexity can be reduced (e.g., simplified plumbing), hydraulic performance can be improved (e.g., thicker conduit walls are generally less prone to performance-robbing distention when under pressure, shorter fluid conduit lengths), and/or actuator reliability can be improved (e.g., internal conduits can be better protected from external damage, thicker conduit wall are generally less prone to cracking, fewer joints for potential leaks.

In the illustrated example, the actuator 1000 includes a housing 1010, a stator 1020, a rotary output shaft 1030, and an end cap 1040. The stator 1020 defines a collection of fluid chambers 1022 and a collection of fluid chambers 1024. The rotary output shaft 1030 is affixed to a collection of rotary pistons (not shown) that can be configured to actuate within the fluid chambers 1022 based on applied fluid pressures in the fluid chambers 1022.

The housing 1010 defines a fluid conduit 1012, a fluid conduit 1014, and a control chamber 1016 formed as bores and/or cavities defined within the housing 1010. In some implementations, the control chamber 1016 can be a fluid cavity that partly defines a directional control valve configured to control the directions and/or rates of flow of fluid through the fluid conduits 1012 and 1014.

The stator 1020 defines a fluid conduit 1026 in fluid communication with the fluid chamber 1022, and defines a fluid conduit 1028 in fluid communication with the fluid chamber 1024.

The end cap 1040 defines a fluid conduit 1042 and a fluid conduit 1044. When the end cap 1040 is assembled to the housing 1010 and the stator 1020, the fluid conduit 1042 fluidically connects the fluid conduit 1012 and the fluid conduit 1026, and the fluid conduit 1044 fluidically connects the fluid conduit 1014 and the fluid conduit 1028.

Since the fluid conduits 1012, 1014, 1042, 1044, 1026, and 1028 are defined as integral parts of the housing 1010, the stator 1020, and the end cap 1040, their walls are relatively stronger and thicker than discrete tubing that is used in more conventional designs. These thicker and stronger walls are less prone to distortion (e.g., expansion, bloating) than conventional tubing. As conventional tubes distort under pressure, hydraulic performance can be negatively impacted (e.g., control precision can be lost, holding accuracy can be lost, long conduits can include greater amounts of compressible fluids such as air that may be trapped in hydraulic fluid). The actuator 1000 can reduce or eliminate such problems by providing integral conduits that are shorter and more structurally robust than conventional conduits.

In some embodiments, two or more of the housing 1010, the stator 1020, and the end cap 1040 can be combined into an integral body. For example, the housing 1010 and the end cap 1040 can be formed of a single, monolithic piece of material.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A rotary actuator comprising:
a housing comprising a first mounting assembly;
a first mounting bracket adapted for attachment to the first mounting assembly at a first proximal end, and adapted at a first distal end for attachment to a first external mounting connector of a first mounting surface;
a second mounting bracket adapted for attachment to the first mounting assembly at a second proximal end, and adapted at a second distal end for attachment to the first external mounting connector;
a rotor assembly rotatably journaled in said housing and comprising a rotary output shaft having a second mounting assembly;
a third mounting bracket adapted for attachment to the rotary output shaft at a third proximal end, and adapted at a third distal end for attachment to a second external mounting connector of a second mounting surface; and
a fourth mounting bracket adapted for attachment to the rotary output shaft at a fourth proximal end, and adapted at a fourth distal end for attachment to the second external mounting connector.

2. The rotary actuator of claim 1, wherein:
(1) the first mounting bracket and the second mounting bracket are formed as separate bodies; or
(2) the third mounting bracket and the fourth mounting bracket are formed as separate bodies; or
(3) both.

3. The rotary actuator of claim 1, wherein:
(1) a first major face of the first mounting bracket abuts a second major face of the second mounting bracket; or
(2) a third major face of the third mounting bracket abuts a fourth major face of the fourth mounting bracket; or
(3) both.

4. The rotary actuator of claim 1, wherein:
the first mounting surface comprises an aircraft airframe structural member; and
the first external mounting connector is proximal a structural rib of the aircraft airframe structural member.

5. The rotary actuator of claim 1, wherein:
the second mounting surface comprises a mounting feature of an aircraft assembly to be actuated; and
the second external mounting connector is proximal a structural rib of the aircraft assembly.

6. The rotary actuator of claim 1, wherein the rotary output shaft comprises a first shaft assembly comprising the second mounting assembly and a second shaft assembly comprising a third mounting assembly.

7. The rotary actuator of claim 6, further comprising:
a fifth mounting bracket adapted for attachment to the second mounting assembly at a fifth proximal end, and adapted at a fifth distal end for attachment to a third external mounting connector of the second mounting assembly; and
a sixth mounting bracket adapted for attachment to the third mounting assembly at a sixth proximal end, and adapted at a sixth distal end for attachment to the third external mounting connector.

8. An aircraft assembly comprising:
an airframe comprising a first mounting surface having a first external mounting connector;
an aircraft member configured to be moved relative to the airframe and comprising a second mounting surface having a second external mounting connector; and
a rotary actuator comprising:
a housing comprising a first mounting assembly;
a first mounting bracket adapted for attachment to the first mounting assembly at a first proximal end, and adapted at a first distal end for attachment to a first external mounting connector of a first mounting surface;
a second mounting bracket adapted for attachment to the first mounting assembly at a second proximal end, and adapted at a second distal end for attachment to the first external mounting connector;
a rotor assembly rotatably journaled in said housing and having a rotary output shaft and comprising a second mounting assembly;
a third mounting bracket adapted for attachment to the rotary output shaft at a third proximal end, and adapted at a third distal end for attachment to a second external mounting connector of a second mounting surface; and
a fourth mounting bracket adapted for attachment to the rotary output shaft at a fourth proximal end, and adapted at a fourth distal end for attachment to the second external mounting connector.

9. The aircraft assembly of claim 8, wherein:
(1) the first mounting bracket and the second mounting bracket are formed as separate bodies; or
(2) the third mounting bracket and the fourth mounting bracket are formed as separate bodies; or
(3) both.

10. The aircraft assembly of claim 8, wherein:
(1) a first major face of the first mounting bracket abuts a second major face of the second mounting bracket; or
(2) a third major face of the third mounting bracket abuts a fourth major face of the fourth mounting bracket; or
(3) both.

11. The aircraft assembly of claim 8, wherein:
the first mounting surface comprises an aircraft airframe structural member; and
the first external mounting connector is proximal a structural rib of the aircraft airframe structural member.

12. The aircraft assembly of claim 8, wherein:
the second mounting surface comprises a mounting feature of an aircraft assembly to be actuated; and
the second external mounting connector is proximal a structural rib of the aircraft assembly.

13. The aircraft assembly of claim 8, wherein the rotary output shaft comprises a first shaft assembly comprising the second mounting assembly and a second shaft assembly comprising a third mounting assembly.

14. The aircraft assembly of claim 13, further comprising:
a fifth mounting bracket adapted for attachment to the second mounting assembly at a fifth proximal end, and adapted at a fifth distal end for attachment to a third external mounting connector of the second mounting surface; and
a sixth mounting bracket adapted for attachment to the third mounting assembly at a sixth proximal end, and adapted at a sixth distal end for attachment to the third external mounting connector.

15. A method of rotary actuation comprising:
providing a rotary actuator comprising:
a housing comprising a first mounting assembly;
a first mounting bracket adapted for attachment to the first mounting assembly at a first proximal end, and adapted at a first distal end for attachment to a first external mounting connector of a first mounting surface;
a second mounting bracket adapted for attachment to the first mounting assembly at a second proximal end, and adapted at a second distal end for attachment to the first external mounting connector;
a rotor assembly rotatably journaled in said housing and having a rotary output shaft and comprising a second mounting assembly;
a third mounting bracket adapted for attachment to the rotary output shaft at a third proximal end, and adapted at a third distal end for attachment to a second external mounting connector of a second mounting surface; and
a fourth mounting bracket adapted for attachment to the rotary output shaft at a fourth proximal end, and adapted at a fourth distal end for attachment to the second external mounting connector;
energizing the rotor assembly;
urging rotation of the rotary output shaft;
urging, by the rotary output shaft, rotation of the third mounting bracket;
urging, by the rotary output shaft, rotation of the fourth mounting bracket; and
urging, by the third mounting bracket and the fourth mounting bracket, motion of the second external mounting connector.

16. The method of claim 15, wherein:
(1) the first mounting bracket and the second mounting bracket are formed as separate bodies; or
(2) the third mounting bracket and the fourth mounting bracket are formed as separate bodies; or
(3) both.

17. The method of claim 15, wherein:
(1) a first major face of the first mounting bracket abuts a second major face of the second mounting bracket; or
(2) a third major face of the third mounting bracket abuts a fourth major face of the fourth mounting bracket; or
(3) both.

18. The method of claim 15, wherein:
the second mounting surface comprises a mounting feature of an aircraft assembly to be actuated; and
the second external mounting connector is proximal a structural rib of the aircraft assembly.

19. The method of claim 15, wherein the rotary output shaft comprises a first shaft assembly comprising the second mounting assembly and a second shaft assembly comprising a third mounting assembly.

20. The method of claim 19, further comprising:
a fifth mounting bracket adapted for attachment to the second mounting assembly at a fifth proximal end, and adapted at a fifth distal end for attachment to a third external mounting connector of the second mounting surface; and
a sixth mounting bracket adapted for attachment to the third mounting assembly at a sixth proximal end, and adapted at a sixth distal end for attachment to the third external mounting connector.
